(19) United States
(12) Patent Application Publication
(10) Pub. No.: US 2025/0386386 A1
(43) Pub. Date: Dec. 18, 2025

(54) METHOD OF ENABLING COMMUNICATION IN A SECOND COMMUNICATION CHANNEL THROUGH INTERMEDIATION IN A FIRST COMMUNICATION CHANNEL

(71) Applicant: Continental Automotive Technologies GmbH, Hannover (DE)

(72) Inventors: David Gonzalez Gonzalez, Egelsbach (DE); Andreas Andrae, Frankfurt am Main (DE); Rikin Shah, Langen (DE); Osvaldo Gonsa, Frankfurt (DE)

(73) Assignee: Continental Automotive Technologies GmbH, Hannover (DE)

(21) Appl. No.: 18/878,691

(22) PCT Filed: Jun. 1, 2023
(86) PCT No.: PCT/EP2023/064641

§ 371 Date: Dec. 24, 2024

(30) Foreign Application Priority Data
Jun. 24, 2022 (DE) 10 2022 206 393.7

(51) Int. Cl. H04W 76/14; H04W 74/0816; H04W 88/04

(52) U.S. Cl. CPC H04W 76/14; H04W 74/0816; H04W 88/04

(57) ABSTRACT

A wireless relay communication apparatus communicates over a first and a second wireless communication channel, which are incompatible in at least one property, aspect, or parameter. A message indicating a capacity to act as a relay in the second communication channel is transmitted over the first or the second wireless communication channel. A transmission, received over the second communication channel from a source communication apparatus, includes information enabling the relay communication apparatus to determine that the transmission is to be relayed to a destination communication apparatus. Accordingly, the relay communication apparatus relays the transmission to the destination communication apparatus over the second communication channel. Alternatively, the relay communication apparatus listens in, on the first communication channel, on a negotiation between source and destination communication apparatus for an impending communication on the second communication channel, and relays received transmissions between the communication apparatus.

### CROSS-REFERENCE TO RELATED APPLICATIONS

The present application is a National Stage Application under 35 U.S.C. § 371 of International Patent Application No. PCT/EP2023/064641 filed on Jun. 1, 2023, and claims priority from German Patent Application No. 10 2022 206 393.7.1 filed on Jun. 24, 2022, the disclosures of which are herein incorporated by reference in their entireties.

### TECHNICAL FIELD

The present invention relates to direct communication between wirelessly connected equipment, also referred to as sidelink communication, which equipment is also arranged for communication via a network infrastructure, typically referred to as uplink or downlink communication. The present invention relates in particular to the discovery of wirelessly connected equipment within radio range and available for relaying transmissions from a transmitter to a receiver via such sidelink communication.

### BACKGROUND

In today's connected world many devices are connected to other devices or systems through wireless connections. Such devices may include portable or mobile devices, sensors, and even motor vehicles. Very often, such devices not only communicate with each other through a wireless network infrastructure such as the well-known 3G, 4G, 5G and future communication networks, but also directly across short distances using sidelink communication.

Notably, such extended communication capability is found, e.g., in Cellular-Vehicle-to-Everything (C-V2X) communication, where it is extensively used in addition to using the up- or downlink connection to the wireless network. This not only reduces the traffic load on the network infrastructure, which invariably causes non-negligible overhead for connection management irrespective of the amount of data transmitted, but also permits faster exchange of data between two or more wireless devices and energy savings as normally required power is smaller than the one needed to reach base stations. In addition, short-range communication permits using higher frequencies, which offer higher data rates. In vehicle-to-vehicle (V2V), vehicle-to-infrastructure (V21) and vehicle-to-pedestrian (V2P) communication, sidelink communication may preferably be used for short-range communication, e.g., for transmitting information or data that may be of imminent importance to a user, including but not limited to location and speed of a nearby vehicle or pedestrian. Vehicle-to-network (V2N) communication, on the other hand, may be used for transmitting information that may not be of imminent importance to a user, e.g., information about a traffic incident or difficult road conditions at some distance ahead. In this context, a user may be a person or a device, e.g., a vehicle providing advanced driving assistance or even driving autonomously.

FIG. 1 a) and b) illustrate various communication paths between devices using a wireless network infrastructure and devices using sidelink communication. FIG. 1 a) shows the exclusive use of a network infrastructure, represented by an antenna symbol. The infrastructure, represented by a traffic light symbol, uses, e.g., a 5G air interface network (Uu) for its infrastructure-to-network communication (I2N). Likewise, vehicles and persons-through mobile devices-use the 5G air interface for their respective vehicle-to-network (V2N) and person-to-network (P2N) communication. FIG. 1b) shows the exclusive use of sidelink communication, i.e., communication bypassing the network infrastructure, represented by the direct links between the participants. It is easy to imagine that, depending on local conditions and requirements, one of the communication channels can be used optionally.

In 5G New Radio systems, stipulated in 3GPP technical standard TS 38.101 (3GPP, for 3rd Generation Partnership Project, is an umbrella term for a number of standards organizations which develop protocols for mobile telecommunications), two frequency ranges will be exploited for mobile communications. A first frequency range, FR1, includes frequency bands within a range starting at 410 MHz and extending to 7125 MHz. A second frequency range, FR2, includes frequency bands from 24.25 GHz to 52.6 GHz. The actual frequency bands used may vary across regions or countries.

It is well known that higher frequencies, while offering higher data rates, have shorter range due to high propagation loss and blockage, notably the frequencies in FR2, which have wavelengths measured in millimetres (mm).

Sidelink communication in C-V2X is likely to also be using frequencies in FR2, as its radio range, which more or less corresponds to a line-of-sight communication, will be sufficient for fast transfers of messages of local relevance to nearby communication apparatus. Such messages of local relevance to users are part of so-called proximity services, or ProSe. However, due to blockage or high propagation loss, the actual radio range may be well below what can normally be expected in certain directions or sectors around a transmitter, and some communication apparatus may not receive messages despite being spatially close to the transmitter.

FIG. 2 shows an exemplary situation in which a direct communication connection between a source communication apparatus, designated S, and a destination communication apparatus, designated D, cannot be physically established, and the communication between those two communication apparatus is, thus, enabled by using a network base station, designated gNB, in a conventional fashion. In the figure the physical connections are shown in solid lines, whereas the logical connection is shown as a dashed twin line. The respective radio ranges of the source and destination communication apparatus, S and D, are indicated by the dash double-dotted ovals. It is easy to see, that the source and destination communication apparatus cannot directly communicate with each other.

For avoiding having to use the network, relaying messages via intermediate devices is a known way of extending the communication range or covering areas not reached by a transmitter's radio signals for some reason. Relaying messages via communication apparatus without involving the network may represent a faster and more resource-effective way of communicating messages locally.

FIG. 3 shows an exemplary situation in which a communication connection between a source communication apparatus, designated S, and a destination communication apparatus, designated D, is physically established by using a relay communication apparatus, designated R, as a relay. Like in FIG. 2 the figure the physical connections are shown in solid lines, whereas the logical connection is shown as a dashed twin line. The respective radio ranges of the source and destination communication apparatus, S and D, are indicated by the dash double-dotted ovals. Again, the source and destination communication apparatus cannot directly communicate with each other.

However, such relaying of messages requires knowledge of the wirelessly connected devices that could act as relays which forward transmissions, in order to find a path for the transmission from the sender to the destination. Such knowledge is typically acquired using discovery protocols.

The 3GPP technical specification TX 23.303 specifies, inter alia, two direct discovery models for enabling ProSe communication.

Model A defines two roles for the ProSe-enabled communication apparatus that are participating in ProSe direct discovery: Announcing communication apparatus and monitoring communication apparatus. The announcing communication apparatus announces certain information that could be used by communication apparatus in proximity that have permission to discover. The monitoring communication apparatus monitors certain information of interest in proximity of announcing communication apparatus. In this model the announcing communication apparatus broadcasts discovery messages at pre-defined discovery intervals and the monitoring communication apparatus that are interested in these messages read them and process them. This model is sometimes also referred to as “I am here” since the announcing communication apparatus would broadcast information about itself, e.g., its ProSe Application Code in the discovery message. Model A supports both open and restricted discovery types.

In model B, which supports only restricted discovery type, two roles for the ProSe-enabled communication apparatus that are participating in ProSe Direct Discovery are defined: The discoverer communication apparatus transmits a request containing certain information about what it is interested to discover. The discoveree communication apparatus that receives the request message can respond with some information related to the discoverer's request. Model B is sometimes also referred to as “who is there/are you there” since the discoverer communication apparatus sends information about other communication apparatus that it would like to receive responses from, e.g., the information can be about a ProSe Application Identity corresponding to a group and the members of the group can respond.

Discovery of communication equipment within the radio range is conventionally done through the same interface that is also used for the communication itself and, consequently, communication apparatus that cannot receive messages exchanged in a discovery process will not be found. FIG. 4 shows an exemplary situation where only a relay communication apparatus, R, can directly communicate with the source and destination communication apparatus, S and D, respectively, and thus only the relay communication apparatus, R, knows that it can act as a relay for the other two communication apparatus and can inform the other two communication apparatus accordingly. The information can be shared using the conventional discovery protocols which assume a correspondence between links radio links used for discovery and communication, both processes being coupled to the same radio interface.

BRIEF SUMMARYThere is, thus, a need for providing an improved method of enabling wireless communication between a source communication apparatus and a destination communication apparatus that are each adapted to communicate over a first wireless communication channel and a second wireless communication channel, which first and second wireless communication channels are incompatible in at least one property, aspect or parameter, and which respective wireless coverage ranges differ but at least partially overlap. In particular, the first wireless communication channel may have a larger coverage range than the second wireless communication channel. In this context the expression wireless coverage range is not limited to a circular radius, but is intended to include odd-shaped areas.

This object is achieved by the methods of independent claims 1 and 7 and the apparatus of independent claims 6 and 10. Advantageous embodiments and developments are provided in the respective dependent claims.

In accordance with a first aspect of the invention a method of operating a wireless communication apparatus that is adapted to communicate over a first wireless communication channel and a second wireless communication channel is presented. The first and second wireless communication channels are incompatible in at least one property, aspect, or parameter. Such properties, aspects or parameters may be of logical nature, e.g., a protocol, coding, and the like, or of physical nature, e.g., a frequency, a modulation, and the like, but are not limited thereto. Under ideal conditions, e.g., in a free space, the coverage range of the first wireless communication channel is larger than the coverage range of the second wireless communication channel. For example, the second wireless communication channel may be of the line-of-sight type, subject to high attenuation in the atmosphere or the like, while the first wireless communication channel may be subject to less attenuation in the atmosphere, benefit from reflexion off objects or the like.

The method in accordance with a first aspect of the invention comprises transmitting, over the first and/or the second wireless communication channel, a first message indicating a capacity of the relay wireless communication apparatus to act as a relay in the second communication channel. The first message may comprise information about other communication apparatus that the relay wireless communication apparatus can communicate with on the second communication channel, e.g., based on previous discovery procedures or communication. For example, when the first message is sent in the context of a discovery protocol, the first message may be transmitted in a discovery layer that is located above the MAC layer in the OSI communication layer model. In 3GPP communication channels the pertinent information may be transmitted over physical control channels, e.g., the physical sidelink control channel PSCCH in 3GPP 5G communication channels, or in dedicated discovery channels.

The method in accordance with the first aspect of the invention further comprises receiving, over the second communication channel, a transmission from a source communication apparatus. The transmission comprises first information enabling the relay communication apparatus to determine that the transmission is to be relayed to a destination communication apparatus. Accordingly, the relay communication apparatus determines, if the transmission is to be relayed, and in the positive case, relays the transmission to the destination communication apparatus over the second communication channel.

Alternatively, the method in accordance with the first aspect of the invention further comprises listening in on a communication, over the first communication channel, between a source communication apparatus and a destination communication apparatus, in which the source communication apparatus and the destination communication apparatus negotiate an impending communication over the second communication channel, in which a relay communication apparatus will be used for relaying. The communication over the first communication channel is public, and may comprise, inter alia, information for identifying the source and destination apparatus or respective applications executed thereon that will communicate. In case multiple relay communication apparatus are available, the source and destination communication apparatus may include an identification of the relay apparatus they intend to use for the impending communication on the second communication channel. The relay apparatus uses the information to prepare itself to act as a relay for transmissions coming from the source and/or destination communication apparatus. As soon as the relay communication apparatus receives a transmission from the source communication apparatus, and relays the transmission to the destination communication apparatus or the source communication apparatus, respectively, over the second communication channel. In this alternative, the actual communication between the source and the destination communication apparatus dispenses with the requirement for messages transmitted over the second communication channel to carry an explicit request to relay.

The first message, the first information, the communication, over the first communication channel, between the source communication apparatus and the destination communication apparatus, and/or the transmission, over the second communication channel, destined to the destination communication apparatus, may comprise, inter alia, one or more of: respective identities, location information, application codes, signal strength, signal-to-noise ratio, error rate, a relay service code, and the like, of the relay, source, and/or destination communication apparatus, and/or a request to relay the transmission. In the context of the present invention, application codes may include ProSe application codes and the like.

The relay service code may be used for indicating the capability of a relay communication apparatus to act as a relay in the second communication channel, either after conducting a proper discovery procedure or discovery-less, i.e., without a conducting a dedicated discovery procedure for an impending communication. The relay service code may also indicate the communication channels the relay can communicate over, its location, and the like. Alternatively, or in addition, the relay service code may be added to a transmission or message, in the source communication apparatus, that is to be relayed. This may help avoiding the need to inform the relay communication apparatus, over a control channel, that messages are to be transmitted, as the relay communication apparatus can deduct from the relay service code that the message is to be relayed.

In one or more embodiments, determining whether or not a transmission is to be relayed, comprises evaluating the location of the source communication apparatus and of the destination communication apparatus, relative to the relay communication apparatus.

Location information may be provided in the form of absolute coordinates, e.g., based on a geolocation system like GPS, GLONASS, BeiDou, and the like, or in the form of relative information with respect to the transmitter, e.g., sectors or an azimuth around the transmitter, which may be referenced to true north or any other reference that is shared amongst all communication apparatus. Combinations of absolute and sectors or azimuth are also conceivable, e.g., in case a signal cannot travel directly, but is reflected on its way from the transmitter to the receiver.

The source and destination communication apparatus may transmit their respective location information during the negotiation. This may help identifying a suitable relay communication apparatus for the impending communication over the second communication channel, in case multiple relay communication apparatus are available, and it may also help the relay communication apparatus to accordingly direct a radio signal, e.g., through beamforming or the like, and/or point an antenna used for receiving and transmitting, preferably electronically.

Accordingly, in one or more embodiments of the methods according to the first and/or the second aspect of the invention, when the information pertaining to a location, of the source, relay, and/or destination communication apparatus is available, the respective method further comprises directing a radio signal and/or pointing an antenna in a direction pointing towards that location, by the respective transmitting and/or receiving communication apparatus. Directing the radio signal and/or pointing an antenna may comprise electronic beam forming or the like.

The service code, or relay service code, mentioned further above may be used for indicating the capability of a relay communication apparatus to act as a relay in a communication channel that is different from the one in which the first message is transmitted. The service code may also be used in the previously mentioned alternative, e.g., during the negotiation, in the first communication channel, between the source and destination communication apparatus, for indicating that an impending transmission over the second communication channel is to be relayed.

In accordance with a second aspect of the invention a relay wireless communication apparatus comprises one or more microprocessors, associated volatile and non-volatile memory, a first wireless communication interface adapted to enable communication over a first communication channel, and a second wireless communication interface adapted to enable communication over a second communication channel. The various elements of the relay wireless communication apparatus are communicatively connected through one or more communication lines or buses. The first and second wireless communication channels are incompatible in at least one property, aspect or parameter. The non-volatile memory stores computer program instructions which, when executed by the microprocessor, configure the relay communication apparatus to execute embodiments of the method in accordance with the first aspect of the invention.

In accordance with a third aspect of the invention a method of operating a source wireless communication apparatus that is adapted to communicate over a first wireless communication channel and a second wireless communication channel is presented. The first and second wireless communication channels are incompatible in at least one property, aspect, or parameter.

For establishing a communication with a destination wireless communication apparatus over the second communication channel, the method in accordance with the third aspect comprises receiving, over the first and/or the second wireless communication channel, a first message from a relay communication apparatus, indicating its capacity to act as a relay in the second communication channel. The first message may comprise information about other communication apparatus that the relay wireless communication apparatus can communicate with on the second communication channel, e.g., based on previous discovery procedures or communication.

The method in accordance with the third aspect of the invention further comprises transmitting, over the second communication channel, a transmission to the relay communication apparatus. The transmission comprises first information enabling the relay communication apparatus to determine that the transmission is to be relayed to a destination communication apparatus.

Alternatively, the method in accordance with the third aspect of the invention further comprises negotiating, with a destination communication apparatus and over the first communication channel, an impending communication over the second communication channel. In the negotiation messages, which are public, inter alia the relay communication apparatus to be used as a relay is indicated. When the negotiation is completed, the source communication apparatus transmits, over the second communication channel, a transmission destined to the destination communication apparatus. The transmission will be automatically relayed by the relay communication apparatus that was identified during the negotiation, which had configured itself to do so when listening in on the negotiation.

In one or more embodiments the first message comprises information about communication apparatus that the relay communication apparatus had previously detected on and/or communicated with over the second communication channel.

In one or more embodiments the first information, the first message, the communication, over the first communication channel, between the source communication apparatus and the destination communication apparatus, and/or the transmission, over the second communication channel, destined to the destination communication apparatus may comprise, inter alia, one or more of: respective identities, location information, application codes, signal strength, signal-to-noise ratio, error rate, a relay service code, and the like, of the relay, source, and/or destination communication apparatus, and/or a request to relay the transmission.

In one or more embodiments the location information of the relay communication apparatus may be used, by the source communication apparatus and the destination communication apparatus and during the negotiation, for identifying and selecting a most suitable relay apparatus amongst multiple relay apparatus that may be available. Selecting may include corresponding addressing of the message to be relayed to the relay communication apparatus, directional transmission, e.g., through beamforming, and the like.

In accordance with a fourth aspect of the invention a source wireless communication apparatus comprises one or more microprocessors, associated volatile and non-volatile memory, a first wireless communication interface adapted to enable communication over a first communication channel, and a second wireless communication interface adapted to enable communication over a second communication channel. The various elements of the relay wireless communication apparatus are communicatively connected through one or more communication lines or buses. The first and second wireless communication channels are incompatible in at least one property, aspect or parameter. The non-volatile memory stores computer program instructions which, when executed by the microprocessor, configure the relay communication apparatus to execute embodiments of the method in accordance with the first aspect of the invention.

The present invention builds on the observation that the coverage areas of communication in FR1 and FR2 as stipulated in the 3GPP TS 38.300 standard family, also referred to as 5G NR, differ significantly, and that the coverage area of FR1 may at least partially include FR2 coverage areas of a number of communication apparatus located within the former. However, the invention is not limited to the 3GPP 5G NR use case, and may be used in pairs of communication channels in accordance with different standards, whose wireless coverage ranges differ from each other. It is, thus, conceivable to use a communication channel in accordance with any one of the 3GPP standards in the source and destination communication apparatus, e.g., for self-discovery and negotiating an impending communication over a WiFi communication channel in accordance with the IEEE 802.11 standard that is to be relayed by a relay communication apparatus. It is even conceivable to use the methods of the present invention in non-3GPP communication channels having different coverage areas.

As the methods and apparatus presented hereinbefore do not require a fixed network infrastructure they may be used advantageously in situations where such network infrastructure is not available for whichever reason.

The methods described hereinbefore may be represented by computer program instructions which, when executed by a microprocessor, cause the microprocessor and/or control hardware components of a relay communication apparatus in accordance with the second aspect of the invention, or of a source communication apparatus in accordance with fourth aspect of the invention, respectively, to execute methods in accordance the first or the third aspect of the invention, respectively.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

The relay and/or source communication apparatus may be a mobile device including, but not limited to a mobile phone, a tablet computer, or a motor vehicle, but may also be a stationary device, including, but not limited to a wireless-enabled IoT device, a road side unit and the like.

### BRIEF DESCRIPTION OF THE DRAWINGS

In the following section, embodiments of the invention will be described with reference to the figures of the drawing. The examples provided in the drawing are illustrative only, and should not be considered limiting the scope of the claims.

FIGS. 1(a) and 1(b) illustrate various communication paths between devices using a wireless network infrastructure and devices using sidelink communication, respectively.

FIG. 2 illustrates an exemplary situation in which a communication connection between a source communication apparatus and a destination communication apparatus is physically established by using a network base station as a relay.

FIG. 3 shows an exemplary situation in which a communication connection between a source communication apparatus and a destination communication apparatus is physically established by using a relay communication apparatus as a relay.

FIG. 4 illustrates an exemplary situation in which only a relay communication apparatus can discover a source communication apparatus and a destination communication apparatus.

FIG. 5 shows an exemplary situation in which the method in accordance with the first aspect of the invention can be advantageously used.

FIG. 6 shows a message flow diagram, or swim-line diagram, of the method of operating wireless communication apparatus in accordance with a first embodiment of the first aspect of the invention.

FIG. 7 shows a flow diagram of the method of operating a relay wireless communication apparatus in accordance with the first embodiment of the first aspect of the invention.

FIG. 8 shows a flow diagram of a method of operating a source wireless communication apparatus in accordance with a first embodiment of the third aspect of the invention.

FIG. 9 shows a message flow diagram, or swim-line diagram, of the method of operating wireless communication apparatus in accordance with a second embodiment of the first aspect of the invention.

FIG. 10 shows a flow diagram of the method of operating a relay wireless communication apparatus in accordance with the second embodiment of the first aspect of the invention.

FIG. 11 shows a flow diagram of a method of operating a source wireless communication apparatus in accordance with a second embodiment of the third aspect of the invention.

FIG. 12 shows an exemplary block diagram of a wireless communication apparatus in accordance with the second or fourth aspect of the invention.

FIG. 13 shows an exemplary message structure for use in accordance with the present invention.

In the figures, identical or similar elements may be referenced using the same reference designators.

### DETAILED DESCRIPTION

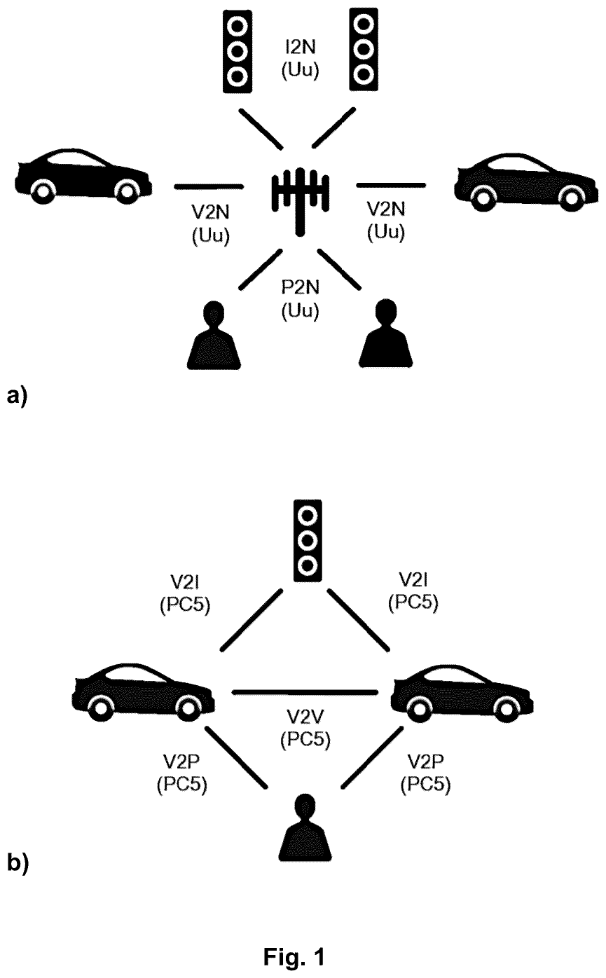

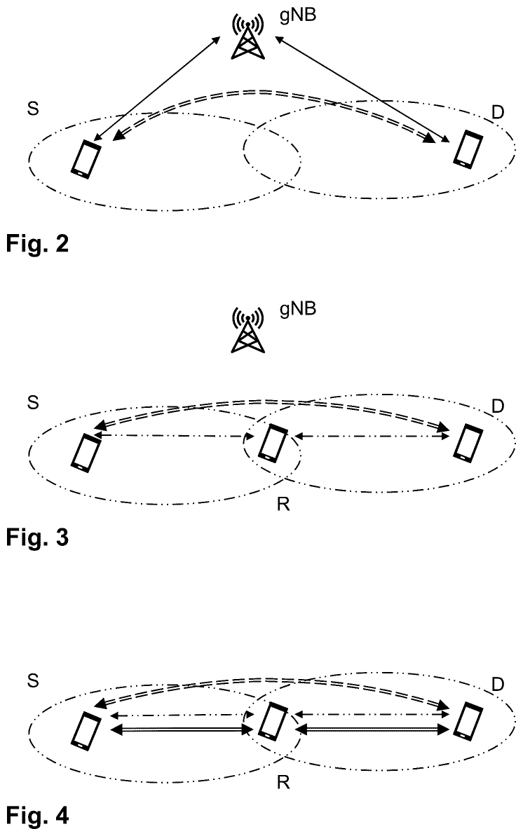

FIGS. 1 through 4 have been described further above and will not be discussed again.

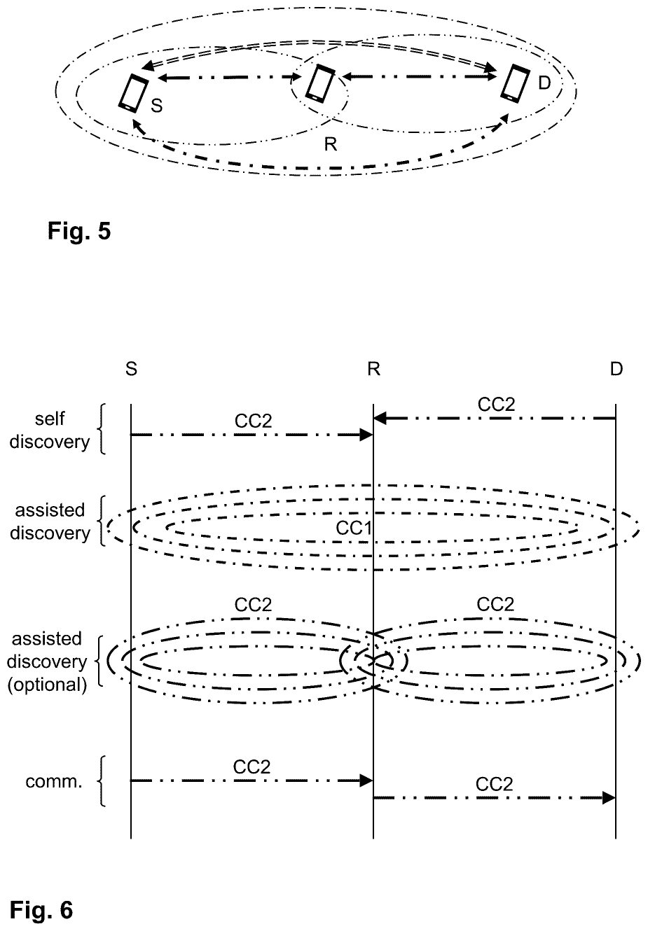

FIG. 5 shows an exemplary situation in which the method 100 in accordance with the first aspect of the invention can be advantageously used. A relay communication apparatus R, which is adapted to communicate over a first communication channel CC1, and which is further adapted to communicate over a second communication channel CC2, is located between a source communication apparatus S and a destination communication apparatus D. The expression “located between” may refer to an actual spatial position somewhere between the source communication apparatus S and the destination communication apparatus D, but may also refer to a “virtual” location “between” the source communication apparatus S and the destination communication apparatus D, i.e., a location, independent from the actual spatial position, in which only the relay communication apparatus R can communicate with both the source communication apparatus S and the destination communication apparatus D over the second communication channel CC2.

Both the source communication apparatus S and the destination communication apparatus D are each located within the coverage range of the second communication channel CC2 of the relay communication apparatus R, but are not within each respective other's coverage range of the second communication channel CC2. In other words, the source communication apparatus S and the destination communication apparatus D cannot communicate directly over the second communication channel CC2. In the figure the coverage range of the second wireless communication channel CC2 is indicated by the dashed double-dotted line.

Note that, while the respective communication ranges of the first and second communication channel CC1 and CC2 are shown as ovals in FIG. 5, they can take any other shape, and their representation in figure is merely illustrative. Note also that the overlap at the relay communication apparatus of the communication ranges of the second communication channel CC2 in FIG. 5 is meant merely to illustrate that the relay communication apparatus R can communicate with both the source communication apparatus S and the destination communication apparatus D, but neither of the source communication apparatus S and the destination communication apparatus D can directly over the second communication channel CC2, as mentioned before.

The source communication apparatus S, the relay communication apparatus R and the destination communication apparatus D are all located within each respective other's coverage range of the first wireless communication channel CC1, indicated in the figure by the dashed-dotted line. In other words, all three communication apparatus can communicate directly over the first communication channel.

Further in FIG. 5, direct communication between the source communication apparatus S and the relay communication apparatus R, and between the relay communication apparatus R and the destination communication apparatus D is indicated by the dashed double-dotted arrows, and direct communication between the source communication apparatus S and the destination communication apparatus D is indicated by the dashed-dotted arrows. The “logical direct” communication between the source communication apparatus S and the destination communication apparatus D, i.e., a communication between the source communication apparatus S and the destination communication apparatus D via the relay communication apparatus R over the second communication channel CC2, is indicated by the dashed twin-lined arrows.

FIG. 6 shows a message flow diagram, or swim-line diagram, of the method of operating wireless communication apparatus in accordance with a first embodiment of the first aspect of the invention, for enabling a communication between a source communication apparatus S and a destination communication apparatus D via a relay communication apparatus R over the second communication channel CC2, e.g., in a situation as illustrated in FIG. 5.

It is assumed that both the source communication apparatus S and the destination communication apparatus D are known to the relay communication apparatus R on the second communication channel, e.g., as a result of a model A self-discovery of the source communication apparatus S and the destination communication apparatus D to the relay communication apparatus R on the second communication channel, or because the source communication apparatus S and the destination communication apparatus D had previously communicated with the relay communication apparatus R. While this self-discovery or previous communication need not have an immediate connection with the operation of the relay communication apparatus R in accordance with the first aspect of the invention, the relay communication apparatus R may assume that the source communication apparatus S and the destination communication apparatus D are still within the coverage range of the second communication channel CC2. For illustrative purposes, in FIG. 6 the source communication apparatus S and the destination communication apparatus D each perform a self-discovery to the relay communication apparatus R.

In accordance with the method in accordance with the first embodiment of the first aspect of the invention, the relay communication apparatus R executes an assisted discovery, for the second communication channel CC2, over the first communication channel CC1. The assisted discovery may be done via groupcast or broadcast in an open or restricted manner, and will include, inter alia, information indicating the relay communication apparatus' R capacity to act as a relay in the second communication channel CC2, and the number and identities of communication apparatus within the coverage range of the relay communication apparatus' second communication channel. Other information provided in the assisted discovery may include one or more of an application code, a relay service code, information about a sub-application and the like. For highlighting the undirected nature of the assisted discovery in the figure, it is indicated by the dash-dotted concentric ovals representing radio waves.

Note that, while in the figure the assisted discovery, for the second communication channel CC2, is done over the first communication channel CC1, it is also conceivable to use the second communication channel CC2, as indicated by the optional assisted discovery represented by the dashed double-dotted concentric ovals.

Further in accordance with the method in accordance with the first embodiment of the first aspect of the invention, the relay communication apparatus R receives, over the second communication channel CC2, a transmission from the source communication apparatus S. Said transmission comprises first information enabling the relay communication apparatus R to determine that the transmission is to be relayed to a destination communication apparatus D. Accordingly, after having determined that the transmission is to be relayed, the relay communication apparatus R relays to the destination communication apparatus D over the second communication channel CC2.

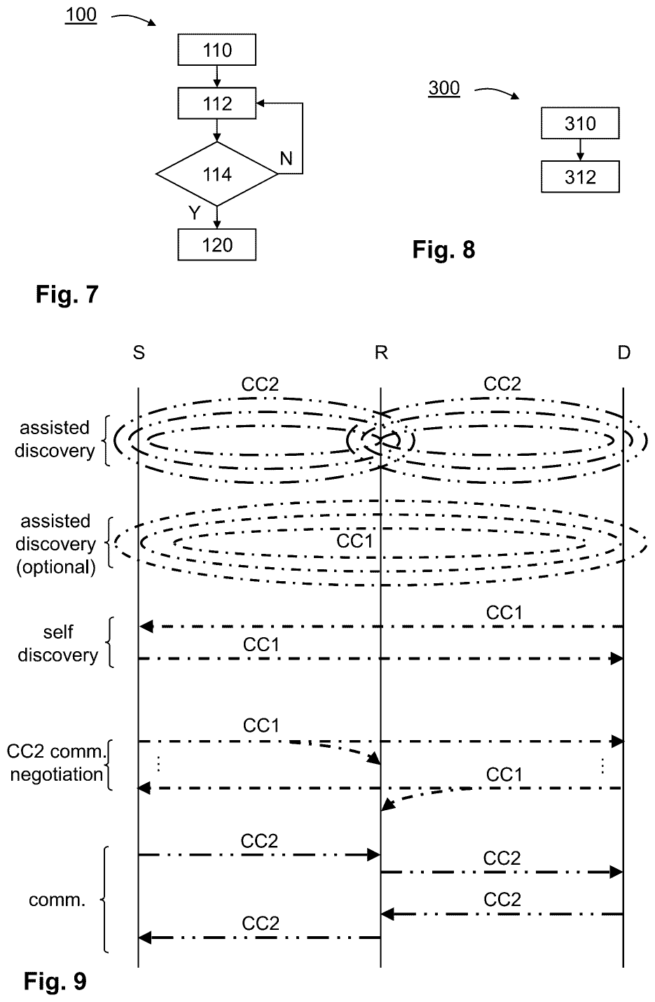

FIG. 7 shows a flow diagram of the method 100 of operating a relay wireless communication apparatus in accordance with the first embodiment of the first aspect of the invention, for enabling a communication between the source communication apparatus S and the destination communication apparatus D via the relay communication apparatus R over the second communication channel CC2.

In step 110 the relay communication apparatus R transmits, over the first CC1 and/or the second CC2 wireless communication channel, a first message indicating the relay communication apparatus' R capacity to act as a relay in the second communication channel CC2. In step 112, the relay communication apparatus R receives, over the second communication channel CC2, a transmission from a source communication apparatus S. Said transmission comprises first information enabling the relay communication apparatus R to determine that the transmission is to be relayed to a destination communication apparatus D. In step 114, the relay communication apparatus R determines, if the transmission is to be relayed. In the positive case, “yes”-branch of step 114, the relay communication apparatus R relays, in step 120, the transmission received in step 112 to the destination communication apparatus D over the second communication channel CC2. In the negative case, “no”-branch of step 114, the relay communication apparatus R returns to step 112, waiting to receive a transmission on the second communication channel CC2.

FIG. 8 shows a flow diagram of a method 300 of operating a source wireless communication apparatus S in accordance with a first embodiment of the third aspect of the invention, for communicating with the destination communication apparatus D via the relay communication apparatus R over the second communication channel CC2.

In step 310 the source communication apparatus receives, over the first CC1 and/or the second CC2 wireless communication channel, a first message from a relay communication apparatus R, indicating its capacity to act as a relay in the second communication channel CC2. The first message comprises information about communication apparatus with which the relay communication apparatus R can establish a communication connection over the second communication channel CC2. In step 312 the source communication apparatus S transmits, over the second communication channel CC2, a transmission to the relay communication apparatus R. Said transmission comprises first information enabling the relay communication apparatus R to determine that the transmission is to be relayed to a destination communication apparatus D.

FIG. 9 shows a message flow diagram, or swim-line diagram, of the method of operating wireless communication apparatus in accordance with a second embodiment of the first aspect of the invention, for enabling a communication between a source communication apparatus S and a destination communication apparatus D via a relay communication apparatus R over the second communication channel CC2, e.g., in a situation as illustrated in FIG. 5.

It is assumed that the relay communication apparatus R had previously executed, over the second communication channel CC2, an assisted discovery. Like in the first embodiment the assisted discovery may be done via groupcast or broadcast in an open or restricted manner, and will include, inter alia, information indicating the relay communication apparatus' R capacity to act as a relay in the second communication channel CC2, and the number and identities of communication apparatus within the coverage range of the relay communication apparatus' second communication channel. Other information provided in the assisted discovery may include one or more of an application code, a relay service code, information about a sub-application and the like. For highlighting the undirected nature of the assisted discovery in the figure, it is indicated by the dashed double-dotted concentric ovals representing radio waves.

Note that, while in the figure the assisted discovery is done over the second communication channel CC2, it is also conceivable to use the first communication channel CC1, as indicated by the optional assisted discovery represented by the dash-dotted concentric ovals.

It is further assumed that the source communication apparatus S and the destination communication apparatus D perform a self-discovery over the first communication channel CC1, i.e., they know the respective other communication apparatus exists. Based on the knowledge of each other's existence, the source communication apparatus S and the destination communication apparatus D negotiate, over the first communication channel CC1, an impending communication between the two communication apparatus over the second communication channel CC2. In this negotiation, which is public, each of the source communication apparatus S and the destination communication apparatus D discloses information about respective relay communication apparatus R it knows to be available, and determine a relay apparatus R to be used for the impending communication over the second communication channel CC2.

In accordance with the second embodiment of the method in accordance with the first aspect of the invention, the relay communication apparatus listens in on the negotiation between the source communication apparatus S and the destination communication apparatus D, indicated by the curved arrows branching off from the respective negotiation message towards the relay communication apparatus R. At the end of the negotiation the relay communication apparatus R is aware that it will need to relay messages, received on the second communication channel CC2, from the source communication apparatus S to the destination communication apparatus D, and vice versa. This is shown in the figure by the relayed communication between the source communication apparatus S and the destination communication apparatus D.

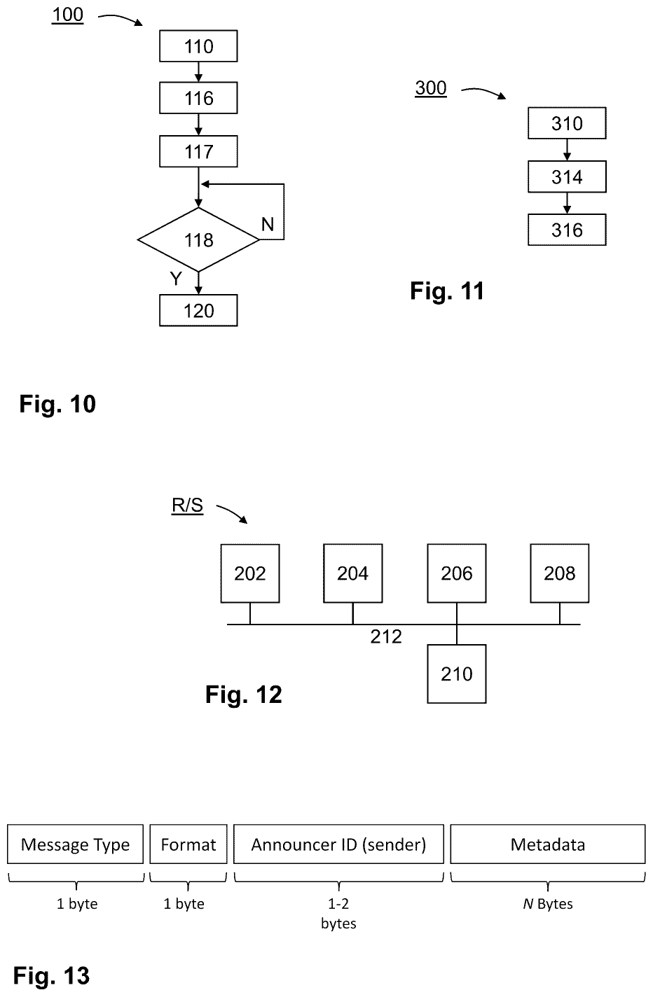

FIG. 10 shows a flow diagram of the method 100 of operating a relay wireless communication apparatus R in accordance with the second embodiment of the first aspect of the invention, for enabling a communication between the source communication apparatus S and the destination communication apparatus D via the relay communication apparatus R over the second communication channel CC2.

In step 110 the relay communication apparatus R transmits, over the first CC1 and/or the second CC2 wireless communication channel, a first message indicating the relay communication apparatus' R capacity to act as a relay in the second communication channel CC2. In step 116, the relay communication apparatus R listens in, on the first communication channel CC1, to a communication between the source communication apparatus S and the destination communication apparatus D, in which the source communication apparatus S and the destination communication apparatus D negotiate an impending communication over the second communication channel CC2, in which the relay communication apparatus R will be used as a relay, and prepares itself accordingly, in step 117, for relaying. In step 118 the relay communication apparatus R waits to receive, over the second communication channel CC2, a transmission from the source communication apparatus S or the destination communication apparatus D. If such transmission is received, “yes”-branch of step 118, it relays, in step 120, the transmission received in step 118 to the destination communication apparatus D over the second communication channel CC2. Otherwise, “no”-branch of step 118, the relay communication apparatus R continues to wait to receive a transmission on the second communication channel CC2.

FIG. 11 shows a flow diagram of a method 300 of operating a source wireless communication apparatus S in accordance with a second embodiment of the third aspect of the invention for communicating with the destination communication apparatus D via the relay communication apparatus R over the second communication channel CC2.

In step 310 the source communication apparatus receives, over the first CC1 and/or the second CC2 wireless communication channel, a first message from a relay communication apparatus R, indicating its capacity to act as a relay in the second communication channel CC2. The first message comprises information about communication apparatus with which the relay communication apparatus R can establish a communication connection over the second communication channel CC2. In step 316 the source communication apparatus S and the destination communication apparatus D negotiate, over the first communication channel CC1, an impending communication over the second communication channel CC2, in which the relay communication apparatus R will be used as a relay. In step 316 the source communication apparatus S transmits, over the second communication channel CC2, a message targeted to the destination communication apparatus D. As the source communication apparatus S and the destination communication apparatus D know that the relay communication apparatus R had listened in on the negotiation over the first communication channel CC1, the messages transmitted over the second communication channel need not carry an explicit request to relay.

FIG. 12 shows an exemplary block diagram of a wireless relay communication apparatus R in accordance with the second aspect of the invention and a wireless source communication apparatus S in accordance with the fourth aspect of the invention. The respective communication apparatus R, S comprises one or more microprocessors 202, a volatile memory 204, a non-volatile memory 206, a first communication interface 208 adapted to communicate via a first communication channel CC1, and a second communication interface 210 adapted to communicate via a second communication channel CC2, the aforementioned elements being communicatively connected via at least one data connection or bus 212. The first and second communication interface 208, 210 may comprise appropriate receiver and transmitter means. The non-volatile memory 206 stores computer program instructions which, when executed by the microprocessor 202, cause the first or second communication apparatus R, S, respectively, to execute the method according to the first or third aspect of the present invention, respectively, as presented above.

FIG. 13 shows an exemplary message structure for use in accordance with the present invention. The exemplary message structure comprises a message type field, a format field, a field for an announcer identification, and a field for additional data, or metadata. In the figure the message type field and the format field each have a length of 1 byte, while the announcer identification field may have a length of 1 or 2 bytes, and the metadata field can have any length that may be required.

The message type field may be used for distinguishing between open or restricted discovery. The format field may be used for indicating parameters or capabilities in the context of relaying messages, of the communication apparatus that sends the message. The format field need not itself convey the actual parameter values, but may provide an information which parameters or capabilities are generally available in the communication apparatus that sends the message. Actual parameter or configuration values may be transmitted in the metadata field. The metadata field may also carry more specific information about a relay communication apparatus to be used. The announcer identification field carries an unambiguous identification of the communication apparatus that sends the message.

The table below shows exemplary values for the format field and their function:

| format | metadata | |
|---|---|---|
| field | length | |
| value | in bytes | metadata structure/content |
| 00000000 | 1 | byte 0: relay service code (RSC) |
| 00000001 | 4 | byte 0: (RSC) |
| | | byte 1-3: location of relay communication |
| | | apparatus (24 bit GPS data) |
| 00000010 | 4 | byte 0: (RSC) |
| | | byte 1-3: bitmap indicating carriers the relay |
| | | communication apparatus can handle |
| 00000011 | 7 | byte 0: (RSC) |
| | | byte 1-3: location of relay communication |
| | | apparatus (24 bit GPS data) |
| | | byte 4-7: bitmap indicating carriers the relay |
| | | communication apparatus can handle |
| 00000100 | 1 | same metadata structure as format field |
| | | 00000000, but with Announcer ID assumed |
| | | to be 2 bytes |
| 00000101 | 4 | same metadata structure as format field |
| | | 00000001, but with Announcer ID assumed |
| | | to be 2 bytes |

Using 1 byte for the format field up to 256 formats can be defined. The format field values, their length and according metadata structure are only exemplary and can be defined as needed.

The format field having a value of 00000000 represents the most basic implementation. No further information, e.g., about location and carriers, is provided, and default values may be used. The announcer identification is assumed to have a length of 1 byte. As mentioned further above, the relay service code represents a parameter identifying a connectivity service the relay communication apparatus can provide, and may also carry information identifying authorized users, security policies to be applied, prioritizing users, and the like.

The format field having a value of 00000001 indicates that a location of the relay communication apparatus is provided in the metadata field. The announcer identification is assumed to have a length of 1 byte.

The format field having a value of 00000010 indicates that information about carriers the relay communication apparatus can handle is provided in the metadata field. The announcer identification is assumed to have a length of 1 byte.

The format field having a value of 00000011 indicates that information about the location of the relay communication apparatus and carriers the relay communication apparatus can handle is provided in the metadata field. The announcer identification is assumed to have a length of 1 byte.

The format field having a value of 00000100 has the same metadata structure or content as the format field having a value of 00000000, but the announcer identification is assumed to have a length of 2 bytes.

The format field having a value of 00000101 has the same metadata structure or content as the format field having a value of 00000001, but the announcer identification is assumed to have a length of 2 bytes.

As mentioned further above, the message structure, which forms what can be dubbed assisted discovery layer, can be transmitted on top of the MAC layer in the OSI layer model.

While in the foregoing description the source, relay and destination communication apparatus are discussed in their respective function only, it should be understood that any communication apparatus may take the role of each other, i.e., the destination communication apparatus may be a source communication apparatus in the same or a different communication, and the source or destination communication apparatus may at as relay communication apparatus in a different communication between different source and destination communication apparatus. Thus, the distinction between source and relay communication apparatus that is used in the attached claims is merely provided for better understanding, and is limited to the respective role or function a communication apparatus is currently in. It does not preclude that a relay communication apparatus can also be a source or destination communication apparatus, or that a source or destination communication apparatus can also be a relay communication apparatus, either simultaneously or sequentially.

### LIST OF REFERENCE NUMERALS (PART OF THE DESCRIPTION)

100 method 210 second wireless communication interface
110 transmit first message
112 receive transmission 212 communication line/bus
114 data to be relayed? 300 method
116 listen on CC1 310 receive first message
118 wait to receive transmission 312 transmit message to be relayed
120 relay data 314 negotiate impending communication
202 microprocessor
204 volatile memory 316 transmit
206 non-volatile memory D destination communication apparatus
208 first wireless communication interface
R relay communication apparatus
S source communication apparatus

1. A method of operating a wireless relay communication apparatus that is adapted to communicate over a first wireless communication channel and a second wireless communication channel, which first and second wireless communication channels are incompatible in at least one property, aspect or parameter, the method comprising:
transmitting, over the first and/or the second wireless communication channel, a first message indicating the relay communication apparatus' capacity to act as a relay in the second communication channel, and
receiving, over the second communication channel, a transmission from a source communication apparatus, said transmission comprising first information enabling the relay communication apparatus to determine that the transmission is to be relayed to a destination communication apparatus,
determining, whether or not the transmission is to be relayed, and if the transmission is to be relayed:
relaying the transmission to the destination communication apparatus over the second communication channel,
or
listening in on a communication, over the first communication channel, between a source communication apparatus and a destination communication apparatus, in which the source communication apparatus and the destination communication apparatus negotiate an impending communication over the second communication channel, and in which the relay communication apparatus will be used as a relay,
receiving, over the second communication channel, a transmission from the source communication apparatus or the destination communication apparatus, and
relaying the transmission to the destination communication apparatus or the destination communication apparatus, respectively, over the second communication channel.

2. The method of claim 1, wherein the first message comprises information about communication apparatus that had previously been detected on and/or communicated with over the second communication channel.

3. The method of claim 1, wherein the first message, the first information, the communication, over the first communication channel, between the source communication apparatus and the destination communication apparatus, and/or the transmission, over the second communication channel destined to the destination communication apparatus, comprises an ID and/or information pertaining to a location, of the destination communication apparatus, and/or a request to relay the transmission.

4. The method of claim 3, wherein determining, if the transmission is to be relayed, comprises evaluating the location of the source communication apparatus and of the destination communication apparatus, relative to the relay communication apparatus.

5. A method of operating a source wireless communication apparatus that is adapted to communicate over a first wireless communication channel and a second wireless communication channel, which first and second wireless communication channels are incompatible in at least one property, aspect or parameter, for establishing a communication with a destination wireless communication apparatus over the second communication channel, the method comprising:
receiving, over the first and/or the second wireless communication channel, a first message from a relay communication apparatus, indicating its capacity to act as a relay in the second communication channel, and
transmitting, over the second communication channel, a transmission to the relay communication apparatus, said transmission comprising first information enabling the relay communication apparatus to determine that the transmission is to be relayed to a destination communication apparatus,
or
negotiating, with a destination communication apparatus and over the first communication channel, an impending communication over the second communication channel, in which the relay communication apparatus to be used as a relay is indicated, and
transmitting, over the second communication channel, a transmission destined to the destination communication apparatus.

6. The method of claim 5, wherein the first message comprises information about communication apparatus that the relay communication apparatus had previously detected on and/or communicated with over the second communication channel.

7. The method of claim 5, wherein the first message, the first information, the communication, over the first communication channel, between the source communication apparatus and the destination communication apparatus, and/or the transmission, over the second communication channel, destined to the destination communication apparatus, comprises an ID and/or information pertaining to a location, of the destination communication apparatus, and/or a request to relay the transmission.

8. The method of claim 6, wherein the information pertaining to a location of the relay communication apparatus is used for identifying and selecting a relay communication apparatus.

9. The method of claim 6, further comprising, when information pertaining to a location, of the source, relay, and/or destination communication apparatus is available:
directing a radio signal and/or pointing an antenna in a direction pointing towards that location by the respective transmitting and/or receiving communication apparatus.

10. A relay wireless communication apparatus comprising one or more microprocessors, associated volatile and non-volatile memory, a first wireless communication interface adapted to enable communication over a first communication channel, and a second wireless communication interface adapted to enable communication over a second communication channel, which are communicatively connected by one or more communication lines or buses, wherein the first and second wireless communication channels are incompatible in at least one property, aspect or parameter, wherein the non-volatile memory stores computer program instructions which, when executed by the microprocessor, configure the relay communication apparatus to perform operations comprising:
transmitting, over the first and/or the second wireless communication channel, a first message indicating the relay communication apparatus' capacity to act as a relay in the second communication channel,
and
receiving, over the second communication channel, a transmission from a source communication apparatus, said transmission comprising first information enabling the relay communication apparatus to determine that the transmission is to be relayed to a destination communication apparatus,
determining, whether or not the transmission is to be relayed, and if the transmission is to be relayed:
relaying the transmission to the destination communication apparatus over the second communication channel,
or
listening in on a communication, over the first communication channel, between a source communication apparatus and a destination communication apparatus, in which the source communication apparatus and the destination communication apparatus negotiate an impending communication over the second communication channel, and in which the relay communication apparatus will be used as a relay,
receiving, over the second communication channel, a transmission from the source communication apparatus or the destination communication apparatus, and
relaying the transmission to the destination communication apparatus or the destination communication apparatus, respectively, over the second communication channel.

11. A source wireless communication apparatus comprising one or more microprocessors, associated volatile and non-volatile memory, a first wireless communication interface adapted to enable communication over a first communication channel, and a second wireless communication interface adapted to enable communication over a second communication channel, which are communicatively connected by one or more communication lines or buses, wherein the first and second wireless communication channels are incompatible in at least one property, aspect or parameter, wherein the non-volatile memory stores computer program instructions which, when executed by the microprocessor, configure the relay communication apparatus to perform operations comprising:
receiving, over the first and/or the second wireless communication channel, a first message from a relay communication apparatus, indicating its capacity to act as a relay in the second communication channel,
and
transmitting, over the second communication channel, a transmission to the relay communication apparatus, said transmission comprising first information enabling the relay communication apparatus to determine that the transmission is to be relayed to a destination communication apparatus,
or
negotiating, with a destination communication apparatus and over the first communication channel, an impending communication over the second communication channel, in which the relay communication apparatus to be used as a relay is indicated, and
transmitting, over the second communication channel, a transmission destined to the destination communication apparatus.

12. (canceled)

13. (canceled)

14. A vehicle having a wireless relay communication apparatus or a wireless source communication apparatus(S) wherein:
the wireless relay communication apparatus comprises one or more microprocessors, associated volatile and non-volatile memory, a first wireless communication interface adapted to enable communication over a first communication channel, and a second wireless communication interface adapted to enable communication over a second communication channel, which are communicatively connected by one or more communication lines or buses, wherein the first and second wireless communication channels are incompatible in at least one property, aspect or parameter, wherein the non-volatile memory stores computer program instructions which, when executed by the microprocessor, configure the relay communication apparatus to perform operations comprising:
transmitting, over the first and/or the second wireless communication channel, a first message indicating the relay communication apparatus' capacity to act as a relay in the second communication channel,
and
receiving, over the second communication channel, a transmission from a source communication apparatus, said transmission comprising first information enabling the relay communication apparatus to determine that the transmission is to be relayed to a destination communication apparatus,
determining, whether or not the transmission is to be relayed, and if the transmission is to be relayed:
relaying the transmission to the destination communication apparatus over the second communication channel,
or
listening in on a communication, over the first communication channel, between a source communication apparatus and a destination communication apparatus, in which the source communication apparatus and the destination communication apparatus negotiate an impending communication over the second communication channel, and in which the relay communication apparatus will be used as a relay,
receiving, over the second communication channel, a transmission from the source communication apparatus or the destination communication apparatus, and
relaying the transmission to the destination communication apparatus or the destination communication apparatus, respectively, over the second communication channel; and
wherein:
the wireless source communication apparatus comprises one or more microprocessors, associated volatile and non-volatile memory, a first wireless communication interface adapted to enable communication over a first communication channel, and a second wireless communication interface adapted to enable communication over a second communication channel, which are communicatively connected by one or more communication lines or buses, wherein the first and second wireless communication channels are incompatible in at least one property, aspect or parameter, wherein the non-volatile memory stores computer program instructions which, when executed by the microprocessor, configure the relay communication apparatus to perform operations comprising:
receiving, over the first and/or the second wireless communication channel, a first message from a relay communication apparatus, indicating its capacity to act as a relay in the second communication channel,
and
transmitting, over the second communication channel, a transmission to the relay communication apparatus, said transmission comprising first information enabling the relay communication apparatus to determine that the transmission is to be relayed to a destination communication apparatus,
or
negotiating, with a destination communication apparatus and over the first communication channel, an impending communication over the second communication channel, in which the relay communication apparatus to be used as a relay is indicated, and
transmitting, over the second communication channel, a transmission destined to the destination communication apparatus.
